(19) United States
(12) Patent Application Publication
(10) Pub. No.: US 2007/0171839 A1
(43) Pub. Date: Jul. 26, 2007

(54) Network interface card for measuring device and method of manufactring same

(75) Inventors: Jouko Sankala, Oulu (FI); Jorme Axelsson, Oulu (FI); Kimmo Maatta, Oulunsalo (FI); Harri Laakkonen, Oulu (FI)

Correspondence Address: BUCHANAN, INGERSOLL & ROONEY PC, POST OFFICE BOX 1404, ALEXANDRIA, VA, 22313-1404, US

(73) Assignee: Nethawk OYJ, Oulu (FI)

(21) Appl. No.: 11/547,970

(22) PCT Filed: Apr. 14, 2005
(86) PCT No.: PCT/FI05/50119

§ 371 Date: Oct. 10, 2006

(30) Foreign Application Priority Data
Apr. 15, 2004 (FI) 20045134

(51) Int. Cl. H04J 1/16; H04L 12/66

(52) U.S. Cl. 370/252; 370/463

(57) ABSTRACT

A network interface card for a measuring device and a manufacturing method thereof. The network interface card comprises a control unit for controlling the operation of the network interface card, and a line connection connected to the control unit for connecting the network interface card to a telecommunication network to be measured. The network interface card further comprises an internal control interface connected to the control unit for connecting the network interface card to an internal local bus of the measuring device and an external control interface connected to the control unit for connecting the network interface card to an external bus of the measuring device.

### FIELD

The invention relates to a network interface card for a measuring device and to a method of manufacturing a network interface card for a measuring device.

### BACKGROUND

In measuring devices of telecommunication networks, network interface cards are used, the line connections comprised by which are used to connect the measuring device to the telecommunication network to be measured. A prior art network interface card comprises one control interface for connection to the measuring device. The control interface is usually either a PCI (Peripheral Component Interconnect) interface or a USB (Universal Serial Bus) interface. The problem in this solution is the requirement for two different network interface cards. Separate equipment and connections for implementing the control interface have to be designed for each card. The cards also have to be manufactured separately.

### BRIEF DESCRIPTION

The object of the invention is to provide an improved network interface card for a measuring device and an improved method of manufacturing a network interface card for a measuring device.

In an aspect of the invention, there is provided a network interface card for a measuring device, comprising a control unit for controlling the operation of the network interface card, and a line connection connected to the control unit for connecting the network interface card to a telecommunication network to be measured. The network interface card further comprises an internal control interface connected to the control unit for connecting the network interface card to an internal local bus of the measuring device and an external control interface connected to the control unit for connecting the network interface card to an external bus of the measuring device.

In another aspect of the invention, there is provided a method of manufacturing a network interface card for a measuring device, comprising: installing a control unit in the network interface card for controlling the operation of the network interface card; and installing a line connection connected to the control unit for connecting the network interface card to a telecommunication network to be measured. The method further comprises: installing an internal control connection connected to the control unit for connecting the network interface card to an internal local bus of the measuring device; and installing an external control interface connected to the control unit for connecting the network interface card to an external bus of the measuring device.

In still another aspect of the invention there is provided a network interface card for a measuring device, comprising measuring connection means for connecting the network interface card to a telecommunication network to be measured. The network interface card further comprises internal control connection means for connecting the network interface card to an internal local bus of the measuring device and external control interface means for connecting the network interface card to an external bus of the measuring device.

The invention brings forth a plurality of advantages. Two versions of a network interface card do not have to be designed and manufactured, only one network interface card. The same network interface card can be installed in the shelter of the covers of a desktop computer when an internal control bus is employed, and externally in a portable computer, optionally encapsulated, when an external control bus is employed. The invention is particularly suitable for measurement use, since network interface cards designed for measurement use are usually manufactured in small series, in which case the design costs of the card are a considerably more significant factor than the manufacturing costs of the card.

### LIST OF FIGURES

In the following, the invention will be described in more detail in connection with embodiments with reference to the accompanying drawings, in which

FIG. 1 shows a measuring device and a typical operating environment thereof;

FIG. 2 shows an embodiment of a network interface card;

FIG. 3 shows an embodiment of the implementation of the interfaces of a network interface card;

FIG. 4 illustrates the use of an internal control interface of a network work interface card;

FIG. 5 illustrates the use of an external control interface of a network interface card;

FIG. 6 illustrates the simultaneous use of an internal control interface and an external control interface of a network interface card;

FIG. 7 shows an embodiment of a network interface card, wherein a carrier board is used for implementing the control interfaces;

FIG. 8 illustrates the connection in series of network interface cards; and

FIG. 9 is a flow diagram illustrating an embodiment of a method of manufacturing a network interface card for a measuring device.

### DESCRIPTION OF EMBODIMENTS

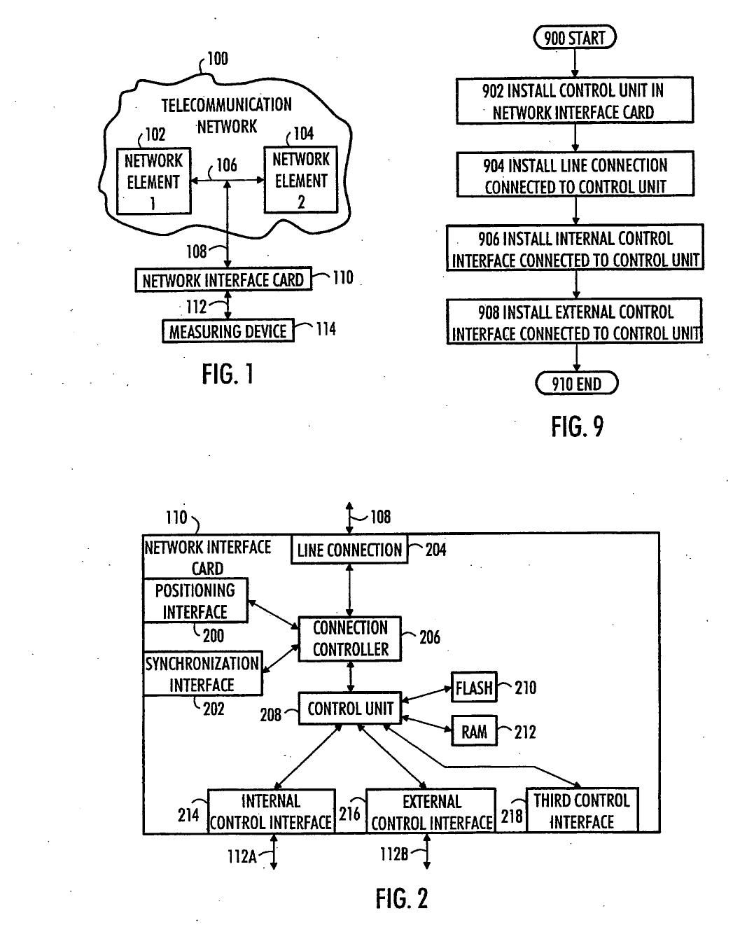

The structure of a measuring device and a typical operating environment thereof will be described with reference to FIG. 1. A measuring device 114 comprises at least one network interface card 110. Measured data and control information, inter alia, are transmitted in a data transfer connection 112 between the measuring device 114 and the network interface card 110. A data transfer connection 108 is provided from the network interface card 110 to a telecommunication network 100 to be measured. In the embodiment of FIG. 1, the data transfer connection 108 from the network interface card 110 to the telecommunication network 100 is established to an interface 106 between two network elements 102, 104.

In the embodiment of FIG. 1, the network interface card 110 can be employed in the measuring device 114 for monitoring the connection 106 between the telecommunication network elements 102, 104. In this case, the network interface card 110 can be connected passively to the line 106 between the network elements 102, 104. The measuring device 114 may control the network interface card 110 via the control interface 112 to capture selected traffic. The network interface card 110 may capture the selected traffic and transmit it to the measuring device 114 for processing. The measuring device 114 may be a device that analyses and/or simulates the operation of a wired and/or wired telecommunication network 100. The product range of Nethawk™ Oyj includes a wide variety of different measuring devices 114. The Applicant's previous patent applications, FI 20031803 and FI 20040397, incorporated herein by reference, include additional information about the more detailed structure and operation of the measuring device 114.

FIG. 2 shows in more detail an embodiment of a network interface card 110. The network interface card may be a medium-long PCI expansion card according to the PCI 2.2 specification, but other dimensions are also feasible.

The network interface card 110 comprises a control unit 208 for controlling the operation of the network interface card and a line connection 204 connected to the control unit 208 for connecting 108 the network interface card to the telecommunication network 100 to be measured.

The line connection 204 may comprise suitable connectors for connecting the network interface card 110 to the telecommunication interface 106 to be tested and a line matching for matching the signals of the telecommunication interface 106 suitable for the network interface card 110. The connectors may be of the RJ45 type, for example. The line matching can be implemented with an Exar XRT83SL28 octet D1/T1 LIU circuit, for example.

In the embodiment of FIG. 2, a connection controller 206 can monitor the line connection 204. The connection controller 206 performs the processing of the lowest protocol levels, for example, when data is received from an E1/T1 (European Digital Signal 1/Digital T-Carrier system) line, it unpacks the E1/T1 framing and attaches a time stamp and a line identifier to the unpacked HDLC (High-level Data Link Control) frames and transfers the HDLC frames to be processed by the control unit 208. The connection controller 206 may be implemented for instance with programmable logic Xilink XC3S1000-Spartan 3. The time stamping of messages is dealt with in the abovementioned patent application FI 20040397.

In addition, the network interface card 110 comprises an internal control interface 214 connected to the control unit 208 for connecting 112A the network interface card to an internal local bus of the measuring device 114 and an external control interface 216 connected to the control unit 208 for connecting 112B the network interface card to an external bus of the measuring device 114.

The control unit 208 may be implemented as a minicomputer comprising the following main parts: a central processing unit (CPU), a working memory and a system clock. The central processing unit comprises three main parts: registers, an arithmetic logical unit (ALU) and a control unit. An Intel® 80321 Xscale processor, for example, can be used as the control unit 208. In FIG. 2, the working memory is a random access memory (RAM) 212 and the program storage memory is a flash memory 210. The control unit 208 may be configured by programming, i.e. by generating the software and data structures including the required functionality, but purely hardware implementations of the control unit 208 are also feasible, for instance a circuit built from separate logic components or one or more application-specific integrated circuits (ASIC). A hybrid of these different implementations is also feasible. When selecting the manner of implementation, a person skilled in the art takes into consideration the requirements set on the size and power consumption of the device, the required processing power, manufacturing costs and production volumes, for example.

The flash memory 210 comprises a program for controlling the operation of the network interface card 110. The control unit 208 starts to execute the program when the network interface card 110 is activated. The program implements the control interface of the network interface card 110. Commands of the control interface are used to control the network interface card 110 to receive messages from given lines, to transmit messages to given lines, to perform filtering of received messages according to selected conditions, to attach tasks to selected received messages, and to perform other useful tasks.

The control unit 208 is used to process the received data: for instance processing of HDLC frames, such as division of E1/T1 timeslots into sub-time slots or combining into hyper channels, and filtration of timeslots, and transfer of processed data via the internal control interface 214 or the external control interface 216 to the measuring device 114.

When data are transmitted to given lines, the control unit 208 receives the data to be transmitted via the internal control interface 214 or the external control interface 216. The control unit 208 is used to generate HDLC frames and the generated frames are transferred to the connection controller 206. The connection controller 206 performs E1/T1 framing of the HDLC frames and transmits the frames via the line connection 204 to the telecommunication interface 106 to be tested.

The network interface card 110 may further comprise a positioning interface 200, via which the measuring device can receive positioning information, allowing the measurements to be bound to an exact time and place. In addition, the network interface card 110 may comprise a synchronization interface 202, via which synchronization information may be received, for performing frame locking, for example. The network interface card 110 may further comprise a third control interface 218, its use being described in more detail later.

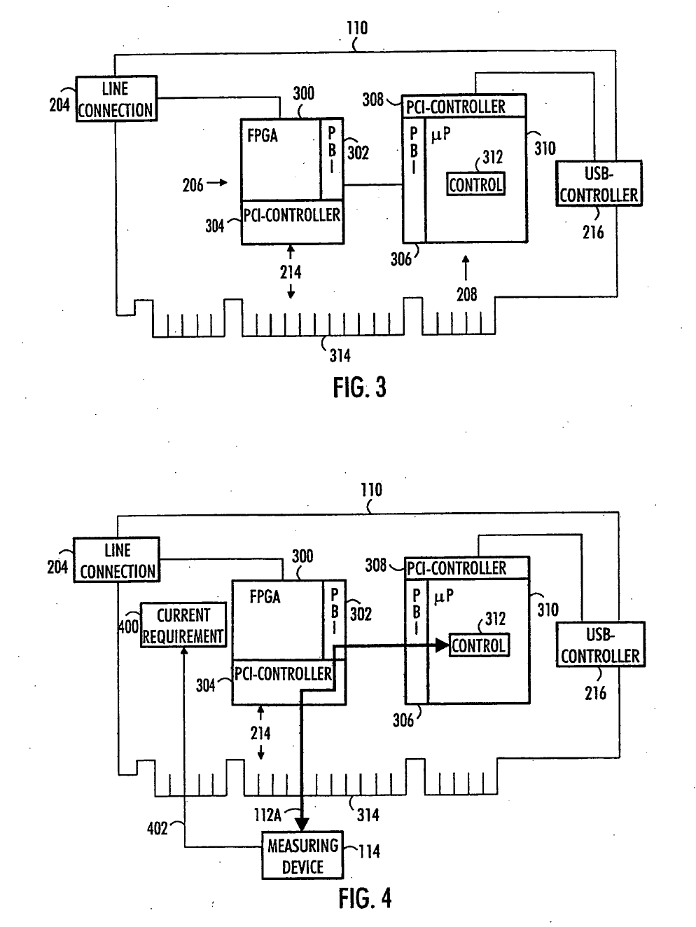

Next, the structure of the network interface card 110 will be described in more detail with reference to FIG. 3, with particular focus on the embodiments of the implementations of the connections. The line connection 204 is connected to a connection controller 206, which is composed of a FPGA (Field Programmable Gate Array) circuit 300, a PCI controller 304 and a PBI (Peripheral Bus Interface) 302. The internal control interface 214 is composed of a PCI controller 304 and a PCI bus 314 provided on the card. The control unit 208 is composed of a microprocessor 310, a PCI controller 308 and a PBI 302. A USB controller (with connectors) 216, connected to the PCI controller 308, serves as the external control interface. The connection controller 206 and the control unit 208 are interconnected with a bus between the PBI:s 302, 306.

The external control interface 214 may be an interface to the internal bus of the computer. In the above-described manner, the internal control interface 214 may be a PCI (Peripheral Component Interconnect) interface, but it may also be another known interface suitable for the purpose to the internal local bus of the measuring device 114.

The external control interface 216 may be an interface to the external bus of a computer. In the above-described manner, the external control interface 216 may be a USB (Universal Serial Bus) interface, but it may also be another wired interface suitable for the purpose to the external bus of the measuring device 114, an IEEE-1394 interface, a PC card interface, a CardBus interface or an Ethernet interface. In an embodiment, the external control interface 216 may be a WLAN (Wireless Local Area Network) interface, a Bluetooth® interface or another known wireless interface suitable for the purpose to the external bus of the measuring device 114.

Next, different embodiments of the network interface card 110 shown in FIG. 3 are described in FIGS. 4, 5, 6 and 7. In the embodiments described, a PCI interface is employed as the internal control interface 214 and a USB interface as the external control interface 216, but it is evident that the embodiments described are not restricted to said bus types, but the above described different bus types can be applied thereto.

FIG. 4 illustrates the use of the internal control interface 214 of the network interface card. The measuring device 114 can be connected to the internal control interface 214, i.e. to the PCI bus 314 controlled by the PCI controller 304. From the PCI controller 304, the internal control interface is connected over the bus between PBI 302 and PBI 306 to control software 312 run in a microprocessor, whereby the software processes control information coming from the control interface and, when need be, transmits the control information to the measuring device 114. A current requirement 400 on the network interface card 110 can be satisfied by current obtained via a bus 402 from the measuring device 114.

The network interface card 110 described in FIG. 4 can be intended for placement in the shelter of a cover of the measuring device 114 when the network interface card 110 is being connected to the internal local bus of the measuring device 114. In an embodiment, the measuring device 114 is a desktop computer, in which case the network interface card 110 is placed inside the covers of the desktop computer.

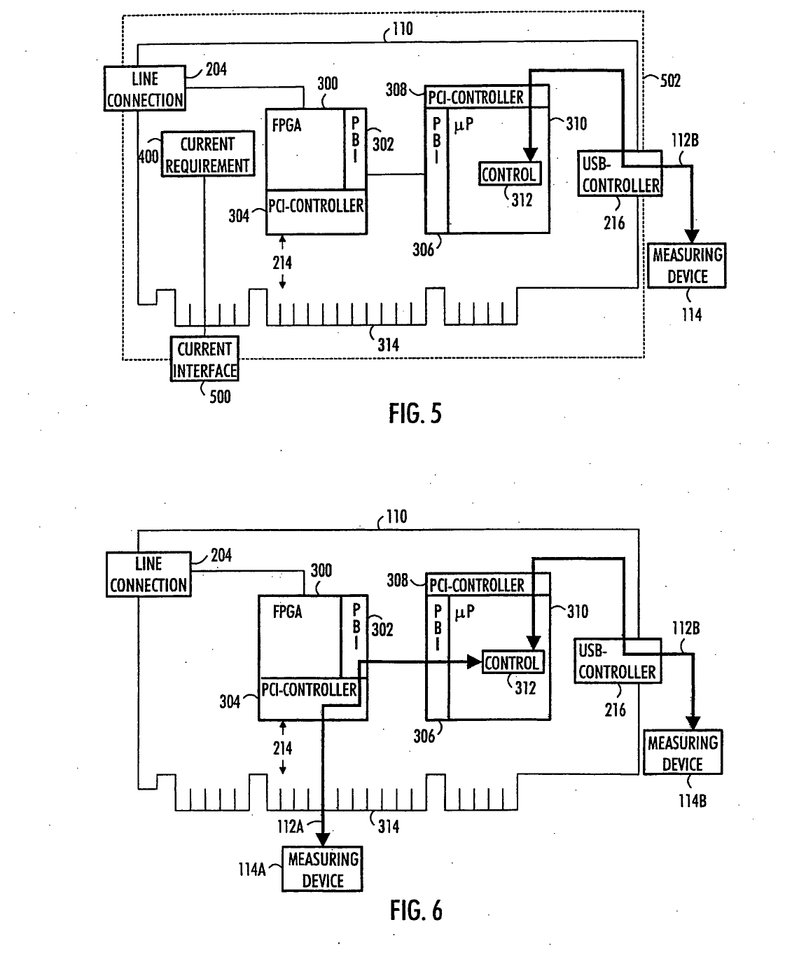

FIG. 5 illustrates the use of the external control interface 216 of the network interface card. The measuring device 114 can be connected to the external control interface, i.e. to the USB controller 216. From the USB controller 216, the external control interface is connected via the PCI controller 308 to the control software run in the microprocessor 310. Not only the external control interface 216, but also the internal control interface 214, is bidirectional, i.e. control information can be transferred bidirectionally between the network interface card 110 and the measuring device 114. For satisfying any current requirement 400 of the network interface card 110, the network interface card 110 can be provided with a current interface 500, to which an external current source can be connected.

In an embodiment, the network interface card 110 described in FIG. 5 may be protectively encapsulated 502 when the network interface card 110 is being connected to the external bus of the measuring device 114. The protective encapsulation 502 may be for instance a dustproof encapsulation made from plastic and/or metal and/or an encapsulation protecting from electromagnetic action. In this embodiment, the measuring device 114 may be for instance a portable computer.

In the embodiments described thus far, the network interface card 110 is connectible to the measuring device 114 by using only either the internal control interface 214 or the external control interface 216 at each particular time. This being so, the control unit 208 may be configured to employ either the internal control interface 214 or the external control interface 216 at each particular time. FIG. 6 illustrates the simultaneous use of the internal control interface 214 and the external control interface 216 of the network interface card 110. A measuring device 114A is connected via the PCI bus 314, the PCI controller 304, and the bus between PBI 302 and PBI 304 to the software 312 run in the microprocessor 310. Two cases can be distinguished from this simultaneous use. In the first case, the measuring device 114A, 114B is the same measuring device, i.e. the network interface card 110 is connectible to the measuring device simultaneously by using both the internal control interface 214 and the external control interface 216. In the second case, the measuring devices 114A, 114B are two separate measuring devices, i.e. the network interface card 110 is connectible simultaneously to the first measuring device 114A by using the internal control interface 214 and to the second measuring device 114B by using the external control interface 216.

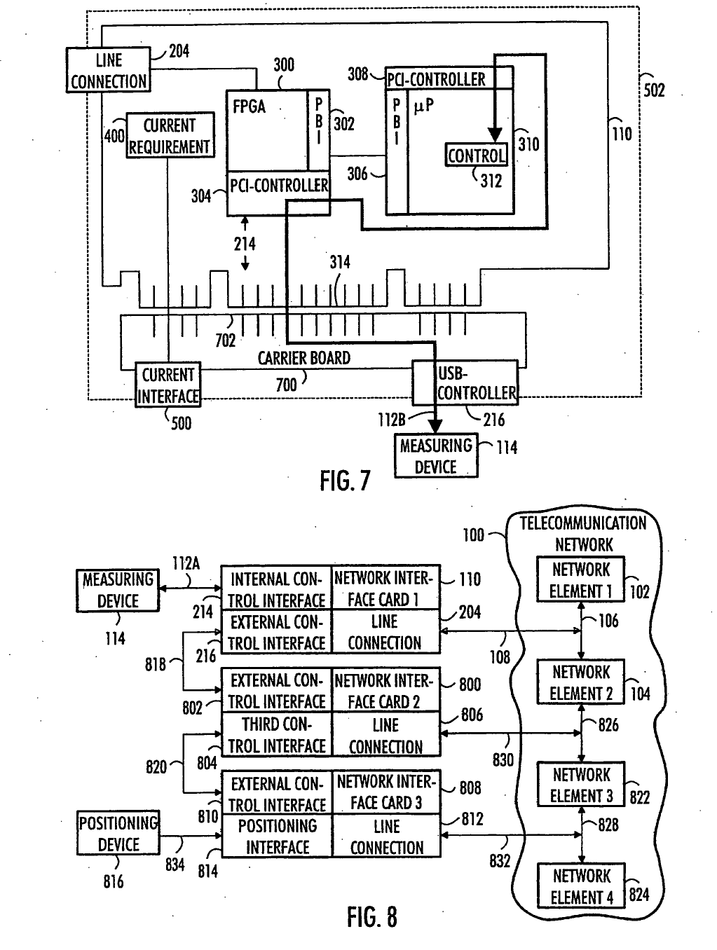

FIG. 7 shows an embodiment of the network interface card 110 wherein a carrier board 700 is used to implement the control interfaces 214, 216. The network interface card 110 may comprise the carrier board 700, which is attachable to the internal control interface 214, and which converts the internal control interface 214 into an external control interface 216. The carrier board 700 may contain a PCI female connector, to which the PCI male connector provided in the network interface card 110 is connected.

In principle, this embodiment can be utilized in such a manner that when the network interface card 110 employing only the internal control interface 214 is to be manufactured, the network interface card 110 described in FIG. 4 may be manufactured, however, without the USB controller 216. When a network interface card 110 employing the external control interface 216 is to be manufactured, the network interface card 110 described in FIG. 7 can be manufactured, wherein the USB controller 216 is placed on the carrier board 700. The external control interface 216 is thus conveyed from the measuring device 114 via the USB controller 216, a PCI bus 702 provided on the carrier board 700 to the PCI bus 314 of the actual network interface card 110, and from there further via the PCI controller 304 and the PCI controller 308 to the control software 312 provided in the microprocessor 310. Without the carrier board 700, the network interface card 110 of FIG. 7 can thus be connected via the internal control interface 214 to the measuring device 114, and with the carrier board 700 via the external control interface 216. The network interface card 110 and its carrier board 700 can be protectively encapsulated 502. A current interface 500, which connects to the current requirement 400, can also be placed on the carrier board 700.

As was stated in association with FIG. 2, the network interface card 110 may comprise a third control interface 218 connected to the control unit 208, via which interface the network interface card 110 is connectible in series with another network interface card. The third control interface 218 may be implemented for instance in the same manner as was described for the external control interface 216. FIG. 8 illustrates the connection of the network interface cards 110, 800, 808 in series. When several network interface cards 110, 800, 808 are connected in series, each network interface card 110, 800, 808 is given a special address, on the basis of which it identifies the traffic incoming to it. All traffic can be transferred to all network interface cards 110, 800, 808, or alternatively, network interface card 110, 800, 808 only identifies the traffic intended for itself and does not transfer it to the other network interface cards 110, 800, 808.

In the embodiment of FIG. 8, the measuring device 114 is connected 112A to the internal control interface 214 of the first network interface card. There is a connection 818 from the external control interface 216 of the first network interface card 110 to the external control interface 802 of the second network interface card 800. There is a connection 820 from the third control interface 804 of the second network interface card 800 to the external control interface 810 of the third network interface card 808. In addition, there is a connection 834 from a positioning interface 814 in the third network interface card 808 to a positioning device 816, which may be a GPS (Global Positioning System) receiver, for example, or another prior art positioning receiver. Since the network interface cards 110, 800, 808 are connected in series in the manner described, positioning information and/or timing information can be conveyed easily from one network interface card 110, 800, 808 to another, and there is thus no need for more than one positioning device 816. Correspondingly, control information can be conveyed easily from the measuring device 114 to the different network interface cards 110, 800, 808. The use of the synchronization interface 202 described in FIG. 2 also enables the transfer of received synchronization information between the series-connected network interface cards 110, 800, 808.

FIG. 8 also describes that the line connection 204 of the first network interface card 110 can be used to connect 108 to the interface 106 between the first and second network elements 102, 104 of the telecommunication network 100, a line connection 806 of the second network interface card 800 can be used to connect 830 to an interface 826 between the second and third network elements 104, 822, and a line connection 812 of the third network interface card 808 can be used to connect 832 to an interface 828 between the third and fourth network elements 822, 824.

Finally, with reference to FIG. 9, an embodiment of the method of manufacturing the network interface card 110 of the above-described measuring device 114 will be described.

The execution of the method starts at 900. Then, at 902, a control unit is installed in the network interface card for controlling the operation of the network interface card. Next, at 904, a line connection connected to the control unit is installed for connecting the network interface card to the telecommunication network to be measured. Then, at 906, an internal control interface connected to the control unit is installed for connecting the network interface card to an internal local bus of the measuring device, and at 908 an external control interface connected to the control unit is installed for connecting the network interface card to an external bus of the measuring device. The execution of the method ends at 910. It is to be noted that the order between the steps comprised by the method is of no significance. The method is applicable both to small-scale series production of network interface cards comprising hand-made fastening of components, making of the network interface card, etc., and to fully automatic manufacture of network interface cards at a robotized factory.

Although the invention is described above with reference to the example in accordance with the accompanying drawings, it will be appreciated that the invention is not to be so limited, but may be modified in a variety of ways within the scope of the appended claims.

1. A network interface card for a measuring device, comprising:
a control unit for controlling the operation of the network interface card;
a line connection connected to the control unit for connecting the network interface card to a telecommunication network to be measured;
an internal control interface connected to the control unit for connecting the network interface card to an internal local bus of the measuring device; and
an external control interface connected to the control unit for connecting the network interface card to an external bus of the measuring device.

2. A network interface card as claimed in claim 1, comprising:
a carrier board which is attachable to the internal control interface and which converts the internal control interface into an external control interface.

3. A network interface card as claimed in claim 1, wherein the network interface card is connectible to the measuring device only by using either the internal control interface or the external control interface.

4. A network interface card as claimed in claim 3, wherein the control unit is configured to use either the internal control interface or the external control interface at a time.

5. A network interface card as claimed in claim 1, wherein the network interface card is connectible to a measuring device simultaneously by using both the internal control interface and the external control interface.

6. A network interface card as claimed in claim 5, wherein the network interface card is connectible simultaneously to the first measuring device by using the internal control interface and to the second measuring device by using the external control interface.

7. A network interface card as claimed in claim 1, wherein the internal control interface comprises an interface to an internal bus of a computer.

8. A network interface card as claimed in claim 1, wherein the internal control interface comprises a Peripheral Component Interconnect (PCI) interface or another known interface to the internal bus of the measuring device.

9. A network interface card as claimed in claim 1, wherein the external control interface comprises an interface an external bus of a computer.

10. A network interface card as claimed in claim 1, wherein the external control interface comprises a Universal Serial Bus (USB) interface, an IEEE-1394 interface, a PC card interface, a CardBus interface or an Ethernet interface, or another known wired interface to the external bus of the measuring device.

11. A network interface card as claimed in claim 1, wherein the external control interface comprises a Wireless Local Area Network (WLAN) interface, a Bluetooth® interface or another known wireless interface to the external bus of the measuring device.

12. A network interface card as claimed in claim 1, wherein the network interface card further comprises:
a third control interface connected to the control unit, via which interface the network interface card is connectible in series with a second network interface card.

13. A network interface card as claimed in claim 1, wherein the network interface card is intended for placement in the shelter of a cover of the measuring device when the network interface card is being connected to the internal local bus of the measuring device.

14. A network interface card as claimed in claim 1, wherein the network interface card is protectively encapsulated when the network interface card is being connected to the external bus of the measuring device.

15. A network interface card as claimed in claim 1, wherein the measuring device comprises:
a device for analysing and/or simulating the operation of a wired and/or wireless telecommunication network.

16. (canceled)

17. A method of manufacturing a network interface card for a measuring device, comprising:
installing a control unit in the network interface card for controlling the operation of the network interface card;
installing a line connection connected to the control unit for connecting the network interface card to a telecommunication network to be measured;
installing an internal control connection connected to the control unit for connecting the network interface card to an internal local bus of the measuring device; and
installing an external control interface connected to the control unit for connecting the network interface card to an external bus of the measuring device.

18. A network interface card for a measuring device, comprising:
measuring connection means for connecting the network interface card to a telecommunication network to be measured;
internal control connection means for connecting the network interface card to an internal local bus of the measuring device; and
external control interface means for connecting the network interface card to an external bus of the measuring device.
